(19) United States
(12) Patent Application Publication
(10) Pub. No.: US 2026/0048493 A1
(43) Pub. Date: Feb. 19, 2026

(54) POWER TOOL WITH HEAT DISSIPATION ELEMENTS

(71) Applicant: MILWAUKEE ELECTRIC TOOL CORPORATION, Brookfield, WI (US)

(72) Inventor: Kentez L. Craig, Milwaukee, WI (US)

(21) Appl. No.: 19/298,613

(22) Filed: Aug. 13, 2025

Related U.S. Application Data
(60) Provisional application No. 63/683,110, filed on Aug. 14, 2024.

(51) Int. Cl. B25F 5/00; B23B 31/22

(52) U.S. Cl. CPC B25F 5/008; B23B 31/22; B25F 5/001

(57) ABSTRACT

A power tool comprising a housing, an electric motor positioned with the housing, a gear case positioned partially within the housing, and a spindle positioned partially within the housing. The electric motor defines a motor axis. The gear case comprises a plurality of first fins extending beyond the housing. The first fins are configured to dissipate heat from the gear case. The spindle is configured to rotate about the motor axis and comprising a tool bit receptacle configured to receive a tool bit.

### CROSS-REFERENCE TO RELATED APPLICATIONS

The application claims priority to U.S. Provisional Ser. No. 63/683,110, filed Aug. 14, 2024, the entire contents of which are incorporated by reference herein.

### FIELD OF THE INVENTION

The present invention relates to power tools.

### BACKGROUND

The present disclosure relates to a power tool including heat dissipation elements for reducing and/or dissipating heat generated during operation of the power tool.

### SUMMARY

In some aspects, the techniques described herein relate to a power tool comprising a housing, an electric motor positioned with the housing, a gear case positioned partially within the housing, and a spindle positioned partially within the housing. The electric motor defines a motor axis. The gear case comprises a plurality of first fins extending beyond the housing. The first fins are configured to dissipate heat from the gear case. The spindle is configured to rotate about the motor axis and comprising a tool bit receptacle configured to receive a tool bit.

In other aspects, the techniques described herein relate to a power tool comprising a housing, an electric motor positioned in the housing, a gear case coupled to the housing, a spindle extending from gear case, and a bit retention assembly positioned on the spindle. The spindle is configured to rotate about an axis and also includes a tool bit receptacle configured to receive a tool bit. The bit retention assembly includes a sleeve moveable between a locked position in which the tool bit is not removable from the tool bit receptacle and an unlocked position in which the tool bit is freely removable from the tool bit receptacle. The sleeve includes a plurality of fins formed on an outer surface of the sleeve and are configured to dissipate heat from the sleeve.

In further aspects, the techniques described herein relate to a power tool comprising a housing, an electric motor positioned in the housing, a gear case coupled to the housing, a planetary gear train, and an impact assembly positioned at least partially within the gear case.

The planetary gear train rotationally coupled to an output of the electric motor. The impact assembly comprising a camshaft, a hammer, an anvil, a rotary bearing, a snap ring, a thrust bearing, a pin, and a pin bearing. The camshaft rotatably coupled an output of the planetary gear train. The hammer is configured to both rotate about and move axially along the camshaft. The anvil is rotatably supported by the gear case and is configured to be selectively contacted by the hammer. The rotary bearing inserted into the gear case and is configured to rotatably support a portion of an anvil. The thrust bearing is positioned between the anvil and the gear case and is configured to reduce friction produced by contact between the anvil and the gear case during operation. The pin is inserted into the camshaft and is configured to align the anvil and the camshaft. The pin bearing is inserted into the anvil and is configured to receive and rotatably support the pin.

### BRIEF DESCRIPTION OF THE DRAWINGS

FIG. 1 illustrates a perspective view of a power tool embodying aspects of the present disclosure.

FIG. 2 illustrates a perspective view of a housing of the power tool of FIG. 1

FIG. 3 illustrates a perspective view of a head portion of a housing of the power tool of FIG. 1.

FIG. 4 illustrates a cut-away perspective view of the head portion of the housing of the power tool of FIG. 1.

FIG. 5 illustrates a section view along line 5-5 of the head portion of the housing of the power tool of FIG. 1.

FIG. 6 illustrates a perspective view of a fan of the power tool of FIG. 1.

FIG. 7 illustrates a gear case of the power tool of FIG. 1.

FIG. 8 illustrates an enlarged side view of the power tool of FIG. 1 and a workpiece.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

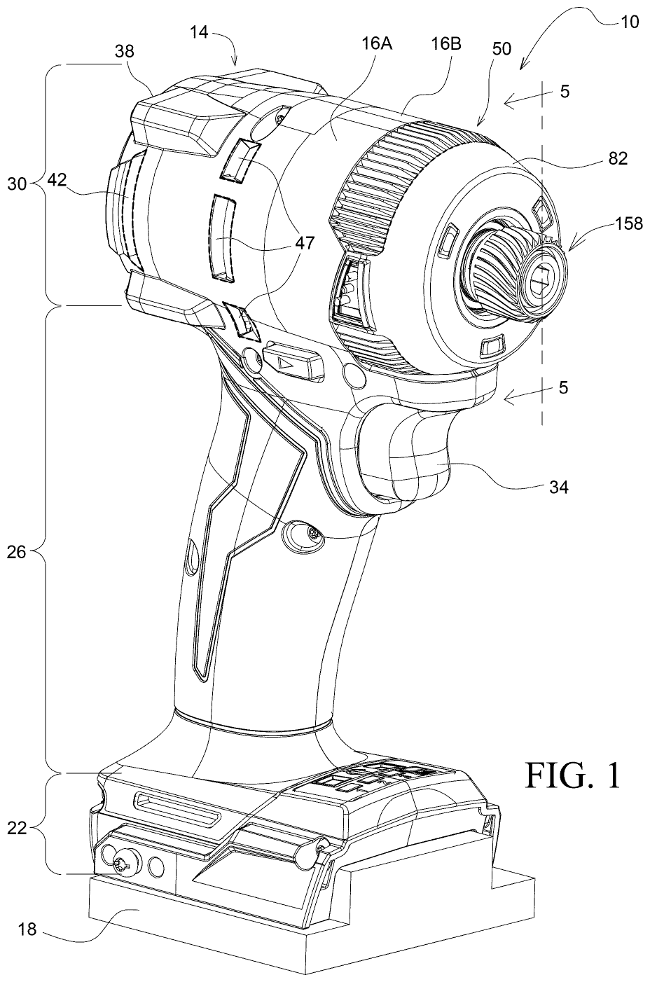

FIG. 1 illustrates a power tool 10 in the form of a rotary impact tool, and, more specifically, an impact driver. In other embodiments, the power tool 10 may be an electric drill or another type of rotary power tool. The illustrated power tool 10 include a housing 14 and a battery pack 18 removably coupled to a battery receptacle located at a foot 22 of the housing 14. The illustrated housing 14 includes a handle portion 26 and a head housing portion 30. The handle portion 26 extends from the head housing portion 30 and terminates at the foot 22.

The handle portion 26 is configured to be held by a user and, in the illustrated embodiment, is covered by a grip made of a material distinct from the remainder of the housing 14. In some embodiments, the grip is over molded on to the handle portion 26. Additionally, the handle portion 26 supports an actuator 34 (e.g., a trigger), which is configured to accept input from the user to initiate operation of the power tool 10.

As shown in FIG. 1-3, the head housing portion 30 is positioned at an end of the handle portion 26 and includes a first clam shell portion 16A and a second clam shell 16B secured together by an end cap 38. Each clam shell portion 16A/B includes at least one intake opening 42, a divider 44, at least one first exhaust opening 47 and a plurality of second exhaust openings 48. Optionally, one of or each of the clam shell portion 16A/B includes a plurality of exhaust channels 46. In the instance that the clam shell portion 16A/B does not include the plurality of exhaust channels 46, there is a single, exhaust channel. In other words, the exhaust channel would not be split up into multiple channels. For the sake of simplicity, the plurality of exhaust channels 46 will be referenced for the reminder of the patent. However, the plurality of exhaust channels 46 may be a single exhaust channel, which functions the same as the plurality of exhaust channels 46. The end cap 38 is coupled to both clam shell portions 16A/B via a plurality of fasteners (not shown).

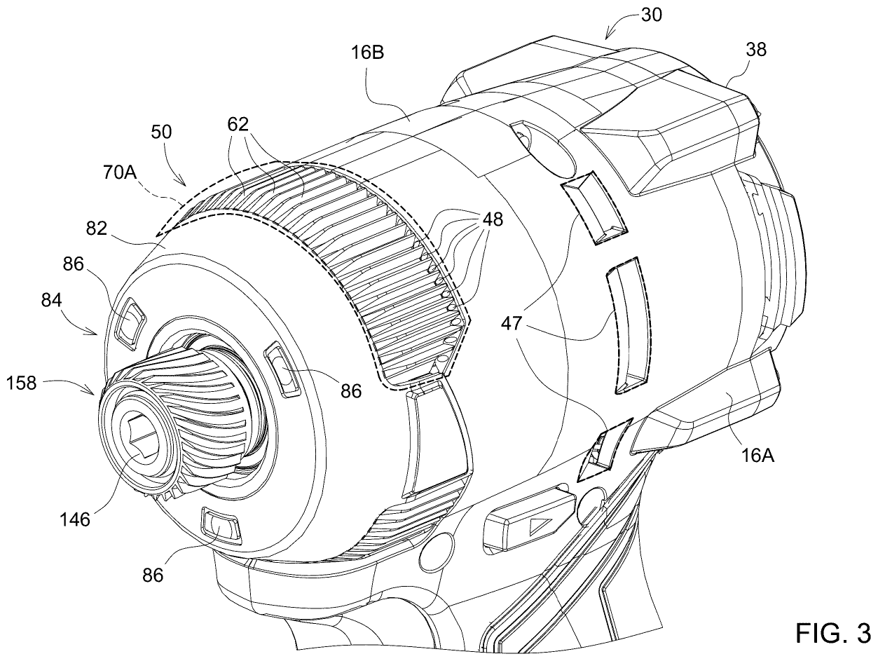

As shown in FIGS. 1 and 3, the intake openings 42 are configured to fluidly connect the inner volume of the head housing portion 30 with the surrounding environment and facilitate the intake of air from the surrounding environment and exhaust air into the surrounding environment.

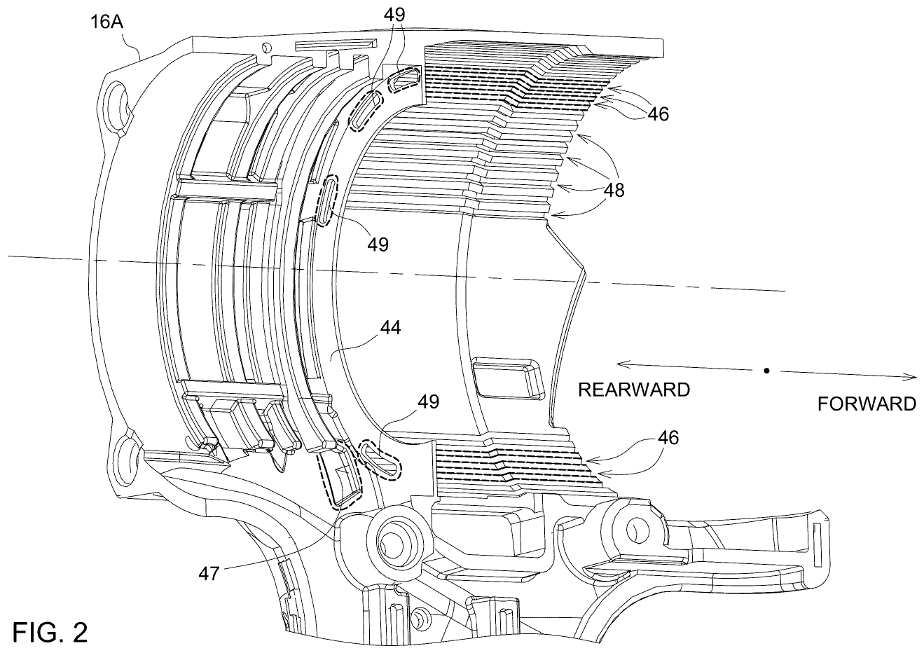

As shown in FIG. 2, the divider 44 is integrally formed on the inner surface of both clam shell portions 16A-B between a front end and a rear end. The divider 44 extends inwardly from the inner surface and is configured to direct airflow in the head housing portion 30.

Additionally, the divider 44 includes a plurality of divider openings 49 arranged circumferentially about the divider 44. The divider openings 49 are configured allow air to pass through the divider 44 and in the general direction of the exhaust channels 46.

With continued reference to FIG. 2, the plurality of exhaust channels 46 are integrally formed along the inner circumference of the head housing portion 30. In the illustrated embodiment, the plurality of exhaust channels 46 receive airflow through the divider openings 49, which passes over the components within the head housing portion 30 and out the first or second exhaust openings 47,48. In the illustrated embodiment, the exhaust channels 46 vary in depth along the head housing portion 30 and shaped to fit around the components within the head housing portion 30.

The at least one first exhaust opening 47 connects the inner volume of the head housing portion 30 with the environment and is configured to reduce back pressure experienced by the air flow through the head housing portion. As shown in FIG. 2, the at least one first exhaust opening 47 is positioned between the front and rear ends of the head housing portion 30 and may aligned with airflow generating components, as discussed in further detail below. In some embodiments, the first exhaust opening 47 may also function as an intake for airflow.

As shown in FIGS. 2-3, the plurality of second exhaust openings 48 are formed at a second end of head housing portion 30 at the end of the exhaust channels 46. The second exhaust openings 48 are configured to expel airflow from the exhaust channels 46 over a portion of the power tool 10 and to the surrounding environment.

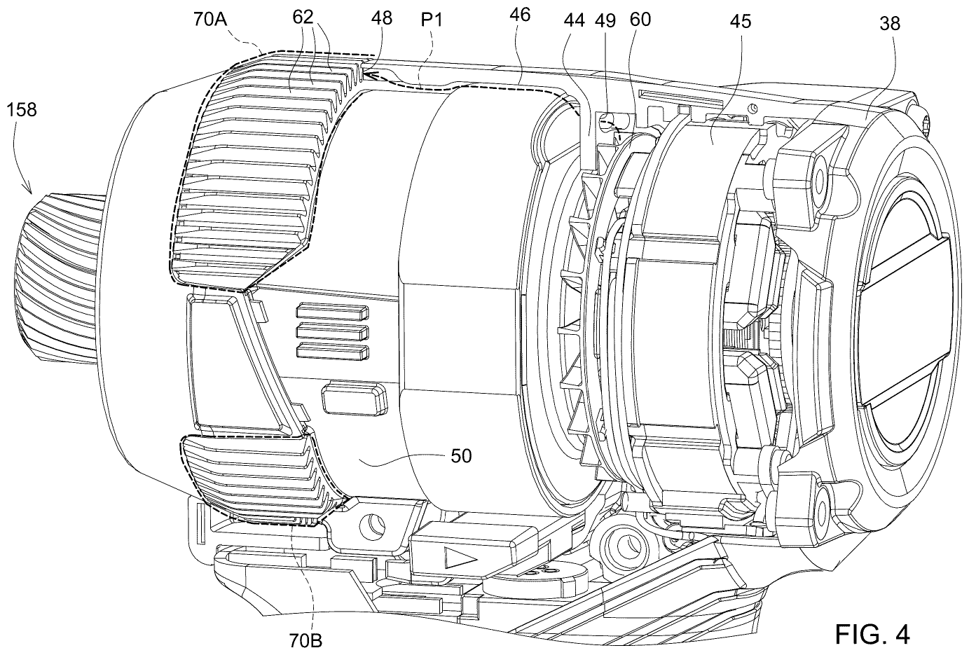

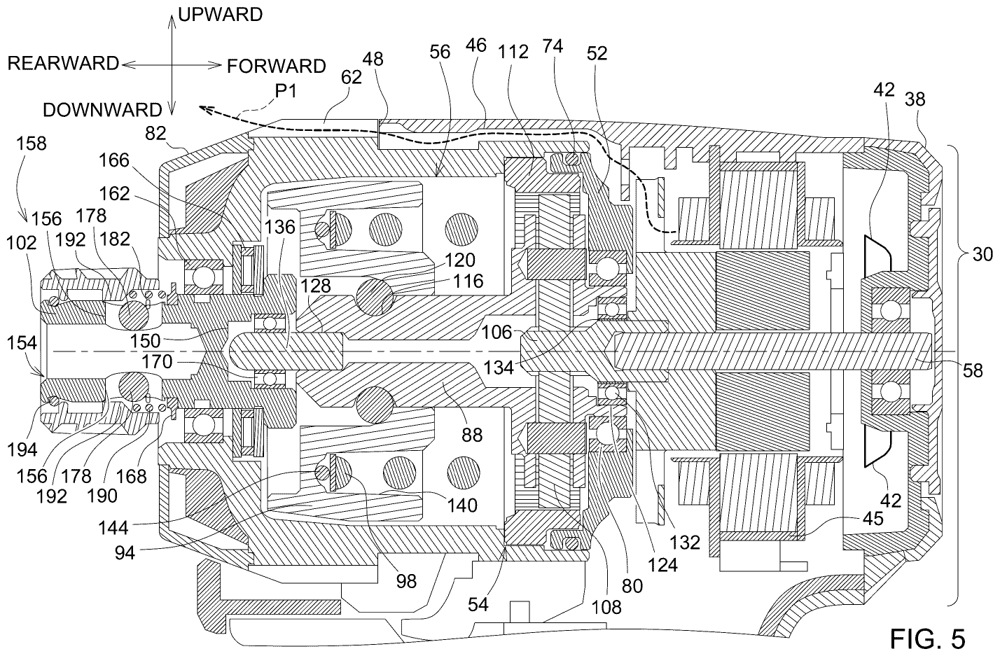

As shown in FIGS. 4-5, the head housing portion 30 encloses an electric motor 45 (e.g., a brushless direct current (“BLDC”) motor) with a stator and a rotor having an output shaft 58 that extends through the stator and is rotatable about a motor axis A1 relative to the stator. A fan 60 is fixed to the output shaft 58 for rotation therewith to generate a cooling airflow along paths P1 during operation of the power tool 10, as described in greater detail below (FIG. 4. In other embodiments, the motor 45 may be another type of motor, such as a brushed motor, an outer-rotor motor, etc.

The output shaft 58 is coupled to a pinion 106, which transmits torque from the motor 45 to a plurality of planet gears 108 meshed with the pinion 106. As shown in FIGS. 3-6, and 7, the illustrated power tool 10 further includes a gear case 50 coupled to the head housing portion 30 and partially enclosed by the head housing portion 30. Each of the plurality of exhaust channels 46 are defined between the clamshell portions 16A/B and the gearcase. In the illustrated embodiment, the gear case 50 is configured to house a gear assembly 54, including the pinion 106, the planet gears 108, and a ring gear 112, and an impact assembly 56, including a camshaft 88, a hammer 94, and an anvil 102, described in greater detail below. During operation, friction in the gear assembly 54 and the impact assembly 56, as well as compression produced by reciprocation of the hammer 94, can generate heat. More specifically, friction is generated through contact between the components of the impact assembly 56 and contact between rotating components and the respective bushings and bearings. Accordingly, the illustrated power tool 10 includes various means for reducing heat generated during operation of the power tool 10 and for more efficiently dissipating generated heat from the power tool 10.

For example, in the illustrated embodiment, the gear case 50 is formed of a metal with relatively high heat conductivity (e.g., aluminum, steel, magnesium, etc.). The gear case 50 includes a plurality of first fins 62 integrally formed with the gear case 50 on an outer surface of the gear case 50 (FIGS. 3-4). The first fins 62 are located on an exposed portion of the gear case 50 that extends beyond the head housing portion 30. The first fins 62 provide an increased surface area to increase the rate of heat transfer (e.g., by convection) between the gear case 50 and the surrounding environment. In the illustrated embodiment, the first fins 62 are straight and parallel to the motor axis A1 and vary in height to match the profile of the head housing portion 30. In other embodiments, the first fins 62 may be segmented, wavy, helical, or have other shapes.

With continued reference to FIGS. 3-4, the illustrated power tool 10 includes a cap 82 coupled to and covering a front portion of the gear case 50. The cap 82 may be made of a plastic material and, in the illustrated embodiment, supports a worklight assembly 84 comprising a plurality of LED light sources 86 spaced circumferentially about the axis A1. The first fins 62 are arranged in two finned regions 70A, 70B located on top and bottom sides of the gear case 50, between the head housing portion 30 and the cap 82. However, in other embodiments, the first fins 62 may be located at other portions of the gear case 50. In further embodiments, the first fins 62 may be arranged along an entire circumference of the gear case 50.

As shown in FIG. 5, a gear case cap 52 is received within a rear end portion of the gear case 50. An O-ring 74 on the gear case cap 52 forms a seal between the gear case cap 52 and the inner wall of the gear case 50 to inhibit lubricant (e.g., grease) contained within the gear case 50 from migrating out of the gear case 50 toward the motor 45. The illustrated gear case cap 52 includes a bearing recess that receives and supports a camshaft bearing 80. The camshaft bearing 80 rotatably supports the camshaft 88 of the impact assembly 56. In the illustrated embodiment, the gear case cap 52 is composed of a heat conductive material (e.g., aluminum, steel, magnesium, etc.), which may be the same or a different material as the material of the gear case 50. In some embodiments, the gear case cap 52 may include a plurality of fins (not shown) positioned on a surface facing the fan 60, which are configured to increase the surface area of the gear case cap 52. The increased surface area of the gear case cap 52 will increase the rate of heat transfer into the surrounding environment. In other embodiments, the gear case cap 52 may include a plurality of fins positioned on a surface facing the ring gear 112 to promote heat transfer out of the gear case 50 through contact with the heated air or the grease in the gear case 50. In further embodiments, both the surface facing the fan 60 and the surface facing the ring gear 112 may include a plurality of fins.

As shown in FIGS. 4-5, the fan 60 is positioned on the output shaft 58 between the electric motor 45 and the gear case cap 52. When the electric motor 45 rotates, the fan 60 rotates simultaneously and moves air through the head housing portion 30 from the intake openings 42 to the first and second exhaust openings 47,48. Airflow paths P1 show exemplary paths along which air moves from the intake openings 42 to the second exhaust openings 48 in the head housing portion 30. The illustrated airflow paths P1 extend along an exterior of the gear case 50, between the gear case 50 and the head housing portion 30. The airflow paths P1 then exit through the second exhaust openings 48 at the front end of the head housing portion 30 adjacent the first fins 62, such that the airflow paths P1 extend over the first fins 62. The flow of air along the airflow paths P1 provides forced convection to cool the electric motor 45, the gear case cap 52, and the gear case 50 (including via the first fins 62), which in turn removes heat from the gear assembly 54 and the impact assembly 56. As a result, the power tool 10 may operate for a relatively longer period of time at a lower average temperature, and the generated heat may be directed away from the user's hands.

In other embodiments, the power tool 10 may be configured with different airflow paths. For example, the fan 60 may be located behind the motor 45 to draw airflow in through the intake openings 42 and discharge the airflow through the exhaust openings 48. In such embodiments, the air drawn into the head housing portion 30 through the intake openings 42 may flow past the first fins 62 to remove heat from the gear case 50. In yet other embodiments (e.g., where less cooling of the gear case 50 is needed), the fan 60 may not generate an air flow passing over the first fins 62, and the first fins 62 may instead cool the gear case 50 only by natural convection. In such embodiments, the fan 60 may be omitted, or the fan 60 may be configured to discharge air from first exhaust openings 47 formed in the head housing portion 30 around the periphery of the fan 60.

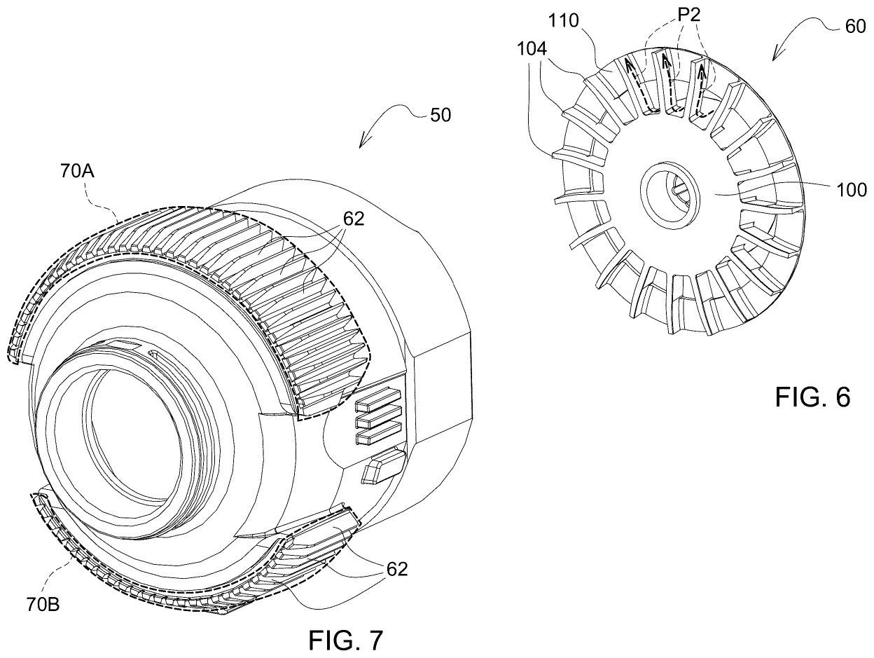

With reference to FIG. 6, the illustrated fan 60 includes a fan hub 100, a plurality of fan blades 104, and a shroud 110. The fan hub 100 is configured to couple to the output shaft 58. The fan blades 104 extend from the fan hub 100 and are configured to draw in air from the intake openings 42 adjacent to the center of the fan 60 and increase the pressure and velocity of the air. Then, the air is directed away from the center of the fan 60, as indicated by the airflow path P2. The shroud 110 is formed on a rear side of each of the fan blades 104 facing the motor 45 (FIG. 6) and extends inwardly from the tips of the fan blade 104 but does not extend to contact the fan hub 100.

Returning to FIG. 5, the illustrated gear assembly 54 is a planetary gear train and includes the pinion 106, the plurality of planet gears 108 meshed with the pinion 106, and the ring gear 112 meshed with the planet gears 108 and rotationally fixed within the gear case 50. The planet gears 108 are mounted on the camshaft 88, which acts as a planet carrier. Accordingly, rotation of the output shaft 58 and pinion 106 rotates the planet gears 108, which then advance along the inner circumference of the ring gear 112 and thereby rotate the camshaft 88 at a reduced speed and increased torque relative to the output shaft 58 of the motor 45.

As shown in FIG. 5, the impact assembly 56 is positioned within the gear case 50 and includes the camshaft 88, the hammer 94, a hammer spring 98, and the anvil 102. The impact assembly 56 is configured to convert the constant rotational force or torque provided by motor 45 via the gear assembly 54 to a striking rotational force or intermittent applications of torque to the anvil 102 when the reaction torque on the anvil 102 (e.g., due to engagement between the tool element and a fastener being worked upon) exceeds a certain threshold.

As shown in FIG. 5, the camshaft 88 of the impact assembly 56 coupled to the hammer 94 via a set of cam grooves 116 and cam balls 120. The cam grooves 116 retain the cam balls 120 and allow for limited relative rotation and limited axial movement of the hammer 94 relative to the camshaft 88. The illustrated camshaft 88 further includes a motor bearing recess 124 and a pin recess 128. The pin recess 128 is formed in a front end of the camshaft 88 and receives a pin 136, described in greater detail below. The motor bearing recess 124 is formed in a rear end of the camshaft 88 and is configured to receive a motor bearing 132. The motor bearing 132 receives and rotatably supports the pinion 106 and a pinion O-ring 134 configured to fill the space between the pinion 106 and the motor bearing 132. By filling the space between the pinion 106 and the motor bearing 132, the relative movement between the pinion 106 and the motor bearing 132 is reduced, thereby reducing heat generated during operation due to friction.

The hammer 94 includes a spring recess 140 and a plurality of hammer lugs (not shown). The spring recess 140 accommodates an end of the hammer spring 98, which, in the illustrated embodiment, is seated against a hammer thrust bearing 144. The hammer spring 98 is configured to bias the hammer 94 in a forward direction (toward the anvil 102). The hammer thrust bearing 144 is positioned between the hammer spring 98 and the hammer 94 to facilitate relative rotation between the hammer 94 and the hammer spring 98. The hammer lugs (not shown) are configured to contact or selectively provide rotational impacts to corresponding lugs (not shown) on the anvil 102 to rotate the anvil about the motor axis A1.

With continued reference to FIG. 5, the anvil 102, which may also be referred to as a spindle, is positioned partially within the gear case 50 and extends partially beyond the gear case 50 to transmit rotation and torque to a tool bit. In the illustrated embodiment, the anvil 102 is rotatably supported by an anvil bearing 162 positioned within the gear case 50. The anvil bearing 162 contacts an outer surface of the anvil 102 and reduces off axis loading experienced by the anvil 102 during operation (e.g., compared to an anvil supported by a bushing). Also shown in the illustrated embodiment, the anvil 102 is axially supported by both an anvil thrust washer 166 and a snap ring 168. The anvil thrust washer 166 limits the contact between the anvil 102 and the gear case 50 (i.e., when the hammer 94 axially impacts the anvil 102) and limits off-axis loads experienced by the anvil 102 during operation. The snap ring 168 also limits contact between the anvil 102 and the hammer 94 (i.e., when a user is applying an axial force on a workpiece 202) and limits off-axis loading during operation of the power tool 10. The reduction in off-axis loading by the anvil bearing 162, the anvil thrust washer 166, and the snap ring 168 all result in a reduction in heat generated during operation of the power tool 10.

The illustrated anvil 102 further includes a pin bearing recess 150, a tool bit receptacle 154, a set of slots 156, and a tool bit retention mechanism 158, described in greater detail below. The pin bearing recess 150 is formed at a first end of the anvil 102 and is configured to receive a pin bearing 170 supported by the pin 136 extending from the camshaft 88. The pin 136 thus aligns the camshaft 88 and the anvil 102. Additionally, the pin 136 inserted into the pin bearing 170 produces less frictional heat compared to directly inserting the pin 136 into a recess in the anvil 102.

In the illustrated embodiment, the pin 136 is press-fitted into pin recess 128 of the camshaft 88, which reduces the stress concentrations at the interface between the pin and the anvil 102. The reduction in stress concentrations improves the service life of the pin 136. In other embodiments, the pin 136 may be installed in the camshaft 88 via a transition fit or an interference fit or the pin 136 may be integrally formed on the camshaft 88. In the illustrated embodiment, the pin 136 is manufactured through press forging. In other embodiments, the pin 136 may be machined or cast. In addition, the illustrated pin 136 includes a rounded end opposite the camshaft 88, which reduces relative speed between the pin 136 and the anvil 102 in the event the pin 136 contacts the anvil 102 during operation. This further reduces wear on the pin 136 and reduces heat generation due to friction.

As shown in FIG. 5, the tool bit receptacle 154 is formed in a front end of the anvil 102 and is configured to receive the tool bit 146. In the illustrated embodiment, the tool bit receptacle 154 has a hexagonal cross section to match the shape of the tool bit 146. In other embodiments, the tool bit receptacle 154 may have a square cross-section, a splined cross-section, a D-shaped cross-section, or another shape depending on the tool bit 146 to be received by the power tool 10. In addition to the tool bit 146, the tool bit receptacle 154 is configured to receive a set of locking balls 178 through a pair of slots 156.

As shown in FIG. 5, the set of slots 156 are formed on the outer surface of the anvil 102 in-between the first end and the second end. The slots 156 are equally circumferentially spaced apart on the outer surface and extend into the tool bit receptacle 154. Each slot 156 receives at least one locking ball 178 and a portion of ball biasing member 182. In other embodiments, each slot 156 may receive only at least one locking ball 178 and the portion of the ball biasing member 182 may be omitted.

As shown in FIG. 5, the tool bit retention mechanism 158 surrounds the first end of the anvil 102 and is configured to couple or release the tool bit 146 into the tool bit receptacle 154. The bit retention mechanism 158 is moveable between a locked position, in which the tool bit 146 is unable to be removed from the tool bit receptacle 154 and an unlocked position, in which the tool bit 146 is freely removably from the tool bit receptacle 154. The tool bit retention mechanism 158 includes the set of locking balls 178, the ball biasing member 182, a sleeve 186, a sleeve biasing member 190, an anvil O-ring 194, and the snap ring 168.

As shown in FIG. 5, the locking balls 178 are positioned in slots 156 of the anvil 102 and are configured to move both axially and radially. In the illustrated embodiment, the tool bit retention mechanism 158 includes two locking balls 178, but in other embodiments the tool bit retention mechanism 158 may include more than 2 or less than 2 locking balls 178. In the locked position, the locking balls 178 are configured to apply a frictional force on the tool bit 146 to increase the force required to remove the tool bit 146. In some embodiments, the locking balls 178 may contact features (i.e., notches or ridges) on the tool bit 146 to further increase the friction between the tool bit 146 and the locking balls 178. In other embodiments, the locking balls 178 may create interference with tool bit 146 to prevent the removal.

As shown in FIG. 5, the ball biasing member 182 is positioned between the snap ring 168 and the locking balls 178 and is configured to bias the locking balls 178 in a forward direction. In the illustrated embodiment, the ball biasing member 182 is a coil spring, but in other embodiments the ball biasing member 182 may be a flat spring or a machined spring. Additionally, the ball biasing member 182 includes an inward projection (not shown) extending into the slots 156 to contact and apply a biasing force to the locking balls 178. In other embodiments, the inward projection of the ball biasing member 182 may be omitted.

As shown in FIGS. 3, 5, and 8, the sleeve 186 surrounds the first end of the anvil 102 and is rotationally locked with respect to the anvil 102. When the sleeve 186 is generally rotationally locked except for backlash between the sleeve and the anvil 102, with respect to the anvil 102. During operation, heat is generated due to the backlash between the sleeve 186 and the anvil 102 and the sleeve 186 includes features to dissipate the accumulated heat, as discussed in greater detail below. In other embodiments, the sleeve 186 may be rotated with respect to the anvil 102. In further embodiments, the sleeve 186 may be rotationally locked in one configuration and rotationally unlocked in another configuration. Additionally, the sleeve 186 is moveable along the motor axis A1 to transition the tool bit retention mechanism 158 between the locked and unlocked position or vice versa. In the locked position, the sleeve 186 is biased in a rearward direction by the sleeve biasing member 190 (i.e., compression spring) positioned between the anvil O-ring 194 and a shoulder of the sleeve 186. When biased in a rearward direction, the shoulder 192 of sleeve 186 directs the locking balls 178 into the tool bit receptacle 154 through the slots 156. To move from the unlocked to locked position, the user applies a force to the sleeve 186 in the forward direction against the sleeve biasing member 190, and as a result the sleeve no longer presses the locking balls into the tool bit receptacle 154. With the locking balls 178 recessed from the tool bit receptacle 154, the tool bit 146 can be freely installed or removed from the tool bit receptacle 154.

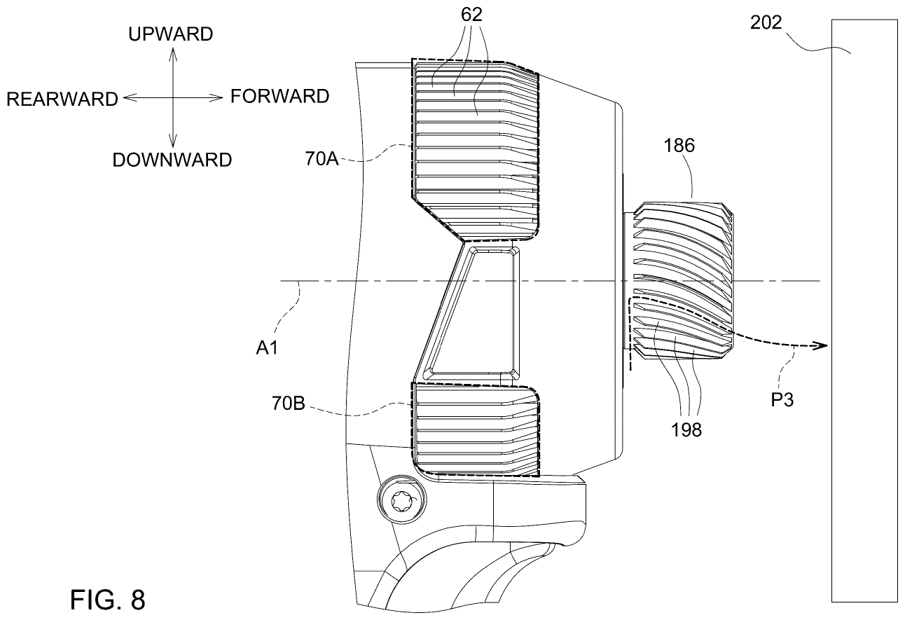

Additionally, the illustrated sleeve 186 includes a plurality of second fins 198 formed on the outer surface of the sleeve 186. The second fins 198 are configured to dissipate heat from the sleeve 186. Specifically, the second fins 198 increase the surface area of the sleeve 186 exposed to the surrounding environment, which increases the rate of heat transfer between the sleeve 186 and the surrounding environment. In the illustrated embodiment, the second fins 198 are helically shaped, which may also provide an enhanced gripping surface for a user to manipulate the sleeve 186; but in other embodiments, the second fins 198 may be straight, segmented, wavy, etc. During operation of the power tool 10, the sleeve 186 rotates about the motor axis A1 in a direction set by the user. During rotation, the second fins 198 may channel the air in a forward direction towards the workpiece 202, as shown by air flow path P3 in FIG. 8. The air flow generated by rotation of the sleeve 186 combined with the airflow from the second exhaust openings 48 may clear dust and debris accumulated on the workpiece 202 and reduce of dust and debris ingress into the tool bit retention mechanism 158 and the remainder of the power tool 10.

Although the invention has been described in detail with reference to certain preferred embodiments, variations and modifications exist within the scope and spirit of one or more independent aspects of the invention as described.

What is claimed is:

1. A power tool comprising:
a housing;
an electric motor positioned with the housing;
a gear case coupled to the housing, the gear case including a plurality of fins extending beyond the housing; and
a spindle extending from the gear case, the spindle configured to rotate about an axis, the spindle comprising a tool bit receptacle configured to receive a tool bit,
wherein the plurality of fins is configured to dissipate heat from the gear case.

2. The power tool of claim 1, further comprising a bit retention assembly positioned on the spindle, the bit retention assembly including a sleeve moveable between a locked position in which the tool bit is not removable from the tool bit receptacle and an unlocked position in which the tool bit is freely removable from the tool bit receptacle, wherein the plurality of fins is a first plurality of fins, and wherein the sleeve includes a second plurality of fins configured to dissipate heat from the sleeve.

3. The power tool of claim 2, wherein the bit retention assembly includes:
one or more locking balls configured to selectively engage the tool bit, and a first spring configured to bias one or more of the locking balls in a first direction.

4. The power tool of claim 2, wherein each fin of the second plurality of fins has a helical shape.

5. The power tool of claim 1, further comprising a fan driven by the electric motor, wherein the housing includes a plurality of intake openings and a plurality of exhaust openings, and wherein the fan is configured to direct air from the plurality of intake openings to the plurality of exhaust openings.

6. The power tool of claim 5, wherein at least one exhaust opening is positioned between at least 2 fins of the plurality of fins of the gear case.

7. The power tool of claim 5, wherein at least one exhaust opening is formed in the housing aligned with an outer periphery of the fan.

8. The power tool of claim 5, further comprising an exhaust channel defined between an outer surface of the gear case and the housing, the exhaust channel extending between the plurality of intake openings and the plurality of exhaust openings.

9. The power tool of claim 5, wherein the fan includes a plurality of blades and a shroud formed on a rear side of each of the plurality of blades.

10. A power tool comprising:
a housing;
an electric motor positioned within the housing;
a gear case coupled to the housing;
a spindle extending from the gear case, the spindle configured to rotate about an axis, the spindle comprising a tool bit receptacle configured to receive a tool bit; and
a bit retention assembly positioned on the spindle, the bit retention assembly including a sleeve moveable between a locked position in which the tool bit is not removable from the tool bit receptacle and an unlocked position in which the tool bit is freely removable from the tool bit receptacle,
wherein the sleeve includes a plurality of fins formed on an outer surface of the sleeve and are configured to dissipate heat from the sleeve.

11. The power tool of claim 10, wherein each fin of the plurality of fins has a helical shape.

12. The power tool of claim 10, wherein the plurality of fins is a first plurality of fins, wherein the gear case includes a second plurality of fins extending beyond the housing, and wherein the second plurality of fins is configured to dissipate heat from the gear case.

13. The power tool of claim 10, wherein the bit retention assembly includes:
one or more locking balls configured to selectively engage the tool bit, and
a first spring configured to bias one or more locking balls in a first direction.

14. The power tool of claim 10, wherein the sleeve is rotationally fixed to the spindle.

15. A power tool comprising:
a housing;
an electric motor positioned within the housing;
a gear case coupled to the housing;
a planetary gear train rotationally coupled to an output of the electric motor; and
an impact assembly positioned at least partially within the gear case, the impact assembly comprising:
a camshaft rotatably coupled an output of the planetary gear train,
a hammer configured to both rotate about and move axially along the camshaft,
an anvil rotatably supported by the gear case, the anvil configured to be selectively contacted by the hammer, the anvil including a tool bit receptacle configured to receive a tool bit,
a rotary bearing inserted into the gear case, the rotary bearing configured to rotatably support a portion of the anvil,
a snap ring installed on the anvil, the snap ring configured to limit axial displacement of the anvil,
a thrust bearing positioned between the anvil and the gear case, the thrust bearing configured to reduce friction produced by contact between the anvil and the gear case during operation,
a pin inserted into the camshaft, the pin configured to align the anvil and the camshaft, and
a pin bearing inserted into the anvil, the pin bearing configured to receive and rotatably support the pin.

16. The power tool of claim 15, wherein the gear case includes a plurality of fins extending beyond the housing, and wherein the plurality of fins is configured to dissipate heat from the gear case.

17. The power tool of claim 16, further comprising a bit retention assembly positioned on the anvil, the bit retention assembly including a sleeve moveable between a locked position in which the tool bit is not removable from the tool bit receptacle and an unlocked position in which the tool bit is freely removable from the tool bit receptacle, wherein the plurality of fins is a first plurality of fins, and wherein the sleeve includes a second plurality of fins configured to dissipate heat from the sleeve.

18. The power tool of claim 15, further comprising a fan driven by the electric motor, wherein the housing includes a plurality of intake openings and a plurality of exhaust openings, and wherein the fan is configured to direct air from the plurality of intake openings to the plurality of exhaust openings.

19. The power tool of claim 15, wherein the pin includes a first end and a second end shaped differently than the first end.

20. The power tool of claim 19, wherein the first end of the pin is rounded.
